(19) United States
(12) Patent Application Publication
(10) Pub. No.: US 2026/0016366 A1
(43) Pub. Date: Jan. 15, 2026

(54) VIBRATION TESTING DEVICE

(71) Applicant: IMV CORPORATION, Osaka (JP)

(72) Inventors: Koichi YOROI, Osaka (JP); Shuhei KAWADA, Osaka (JP)

(21) Appl. No.: 19/338,094

(22) Filed: Sep. 24, 2025

Related U.S. Application Data
(63) Continuation of application No. PCT/JP2025/004592, filed on Feb. 12, 2025.

(30) Foreign Application Priority Data
May 31, 2024 (JP) 2024-089268

(51) Int. Cl. G01M 7/02

(52) U.S. Cl. CPC G01M 7/027

(57) ABSTRACT

The vibration testing device includes a vibration generator having a rotary shaft rotatably supported on a support frame, and a clamp device using gas as working fluid. The clamp device has a first member and a second member, and is switchable by the working fluid between an unlock state in which relative rotation of the first member and the second member is allowed and a lock state in which the relative rotation is restricted. One of the first member or the second member is fixed to the support frame, and the other is fixed to the rotary shaft. The clamp device switches between the unlock state and the lock state to switch between allowing and restricting the rotation of the vibration generator relative to the support frame.

### TECHNICAL FIELD

The present invention relates to a vibration testing device capable of changing the vibration direction of a vibration generator by rotating the vibration generator relative to a support frame.

### BACKGROUND ART

There has been known a vibration testing device for performing a vibration test on various articles such as automobile parts. The vibration testing device includes a vibration generator (for example, see Patent Document 1). The vibration generator disclosed in Patent Document 1 is an electrodynamic vibration generator, and includes an excitation coil that generates a static magnetic field, a drive coil disposed in a magnetic gap formed by the static magnetic field, and a vibration table to which the drive coil is attached.

In the vibration generator as in Patent Document 1, the vibration test is performed, in which the test piece is fixed to the vibration table and is vibrated in the vertical direction. However, not only the vibration test in which the test piece is vibrated in the vertical direction but also a vibration test in which the test piece is vibrated in the horizontal direction may be required. For this reason, conventionally, there has been known a vibration testing device in which a vibration generator is rotatably attached to a support frame and a vibration direction is changeable between the vertical direction and the horizontal direction.

FIG. 10 is a perspective view of part of a known vibration testing device 100. As illustrated in FIG. 10, the vibration testing device 100 includes a support frame 120 and a substantially circular columnar vibration generator 130. The support frame 120 includes a bottom member 122 extending in the left-right direction, a left wall 123 attached to a left end portion of the bottom member 122, and a right wall 124 attached to a right end portion of the bottom member 122. The vibration generator 130 is disposed between the left wall 123 and the right wall 124. The vibration generator 130 has a main body 131 and a pair of rotary shafts 132, 132. The pair of rotary shafts 132, 132 is provided on the side surface of the main body 131. The pair of rotary shafts 132, 132 is supported by the left wall 123 and the right wall 124, whereby the vibration generator 130 is rotatably supported on the support frame 120. The vibration testing device 100 is provided with a rotation operation handle 160, and the vibration direction of the vibration generator 130 can be changed to the vertical direction or the horizontal direction by manually rotating the vibration generator 130 relative to the support frame 120.

### CITATION LIST

### Patent Document

Patent Document 1: Japanese Unexamined Patent Publication No. 2023-100553

### SUMMARY OF THE INVENTION

### Technical Problem

When the vibration test is performed using the vibration testing device, a great rotational moment may act on the vibration generator due to a reaction force or the like generated by vibrating the test piece. If the vibration direction of the vibration generator is shifted during the vibration test, the accuracy of the vibration test is degraded, and for this reason, it is necessary to restrict the rotation of the vibration generator relative to the support frame against the great rotational moment acting on the vibration generator. The known vibration testing device 100 above has a structure in which the vibration generator 130 is fixed to the support frame 120 by multiple fastening members 140 to restrict the rotation of the vibration generator 130.

Thus, when the vibration direction of the vibration generator 130 is changed from the vertical direction to the horizontal direction, for example, it is necessary to perform a process of temporarily removing all the fastening members 140 to allow the rotation of the vibration generator 130, then operating the rotation operation handle 160 in this state to rotate the vibration generator 130 and change the vibration direction from the vertical direction to the horizontal direction, and attaching the fastening members 140 again to restrict the rotation of the vibration generator 130. This changing process is accompanied by the detachment and attachment of the total of eight fastening members, four on the right side and four on the left side, for example, in the vibration testing device 100 of FIG. 10, and there is a problem that it takes time and effort to change the vibration direction of the vibration generator 130.

Here, it is conceivable to use a hydraulic mechanism in order to restrict the rotation of the vibration generator against the great rotational moment acting on the vibration generator while saving a labor for the process of changing the vibration direction of the vibration generator. For example, if the rotation of the vibration generator relative to the support frame can be switched between allowing and restricting by a hydraulic valve switching operation or the like, it is considered that the labor for the process of changing the vibration direction of the vibration generator can be saved and the vibration generator can resist the great rotational moment acting on the vibration generator due to a hydraulic pressure.

However, the hydraulic mechanism may cause leakage of hydraulic oil, and may contaminate test environment around the vibration testing device. Further, if the hydraulic mechanism is constantly operated in order to restrict the rotation of the vibration generator during the vibration test, there is also a problem that the consumption of electric power or the like for operating the hydraulic mechanism increases.

The present invention has been made in view of the above problems, and an object thereof is to provide a vibration testing device capable of saving a labor for a process of changing the vibration direction of a vibration generator, reliably restricting rotation of the vibration generator relative to a support frame during a vibration test, and reducing contamination of test environment as in a case of using a hydraulic mechanism.

### Solution to the Problem

The vibration testing device of the present invention is a vibration testing device capable of changing a vibration direction of a vibration generator, including: a support frame; a vibration generator having a rotary shaft rotatably supported on the support frame; and a clamp device using gas as working fluid, the clamp device has a first member and a second member, and is configured to be switchable by the working fluid between an unlock state in which relative rotation of the first member and the second member is allowed and a lock state in which the relative rotation of the first member and the second member is restricted, either one of the first member or the second member is fixed to the support frame, the other one of the first member or the second member is fixed to the rotary shaft, and the clamp device switches between the unlock state and the lock state to switch between allowing and restricting rotation of the vibration generator relative to the support frame.

### Advantages of the Invention

According to the vibration testing device of the present invention, the labor for the process of changing the vibration direction of the vibration generator can be saved, the rotation of the vibration generator relative to the support frame can be reliably restricted during the vibration test, and the contamination of the test environment as in the case of using the hydraulic mechanism can be reduced.

### BRIEF DESCRIPTION OF THE DRAWINGS

FIG. 1 is a side view of a vibration testing device according to one embodiment of the present invention.

FIG. 2 is a front sectional view of the vibration testing device.

FIG. 3 is a plan view of the vibration testing device.

FIG. 4 is a side view of the structures of a vibration generator and a rotation drive unit in the vibration testing device.

FIG. 5 is a side view of a state in which the vibration generator is rotated by 90 degrees from the state of FIG. 4.

FIG. 6 is a sectional view of a main portion, which illustrates a safety mechanism in an activated state and a peripheral portion thereof.

FIG. 7 is a sectional view of the main portion, which illustrates the safety mechanism in a deactivated state and the peripheral portion thereof.

FIG. 8 is a schematic diagram illustrating a pneumatic circuit and a control system for operating a clamp device and the safety mechanism.

FIG. 9A is a flowchart for describing operations of the clamp device and the safety mechanism.

FIG. 9B is a flowchart for describing the operations of the clamp device and the safety mechanism.

FIG. 10 is a perspective view of part of a known vibration testing device.

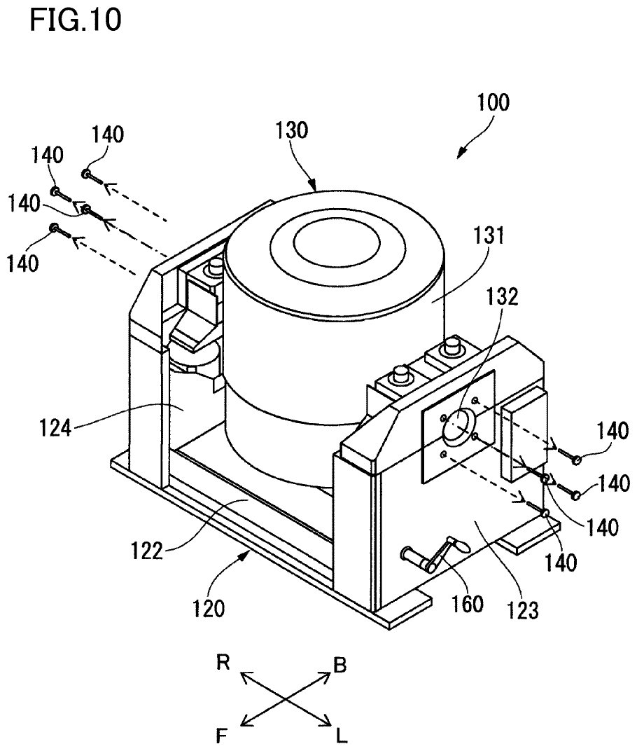

### DESCRIPTION OF EMBODIMENTS

A vibration testing device according to one embodiment of the present invention is a vibration testing device capable of changing the vibration direction of a vibration generator, which includes: a support frame; a vibration generator having a rotary shaft rotatably supported on the support frame; and a clamp device using gas as working fluid, wherein the clamp device has a first member and a second member, and is configured to be switchable by the working fluid between an unlock state in which relative rotation of the first member and the second member is allowed and a lock state in which the relative rotation of the first member and the second member is restricted, either one of the first member or the second member is fixed to the support frame, the other one of the first member or the second member is fixed to the rotary shaft, and the clamp device switches between the unlock state and the lock state to switch between allowing and restricting rotation of the vibration generator relative to the support frame (first configuration).

According to the above configuration, by controlling the gas as the working fluid, it is possible to automate the allowing of the rotation of the vibration generator and the restricting of such rotation. Thus, a process of attaching and detaching a fastening member for fastening the support frame and the vibration generator as in a known vibration testing device is not required, and a labor for a process of changing the vibration direction of the vibration generator can be saved. In addition, in the lock state of the clamp device, the relative rotation of the rotary shaft of the vibration generator and the support frame is restricted, and therefore, the rotation of the vibration generator relative to the support frame can be reliably restricted during a vibration test. Further, since the clamp device uses the gas as the working fluid, there is no leakage of hydraulic oil as in a case of using a hydraulic mechanism, and contamination of test environment can be reduced.

In the first configuration, the clamp device may have the first member having a circular hole, and the second member disposed in the circular hole so as to be rotatable relative to the first member, and may be configured to be switched to the unlock state in a state in which the inside is pressurized by the working fluid and to be switched to the lock state in a state in which the inside is made lower in pressure than in the unlock state, the first member may be fixed to the support frame, and the second member may be fixed to the rotary shaft (second configuration).

According to the above configuration, the clamp device is switched to the lock state in the state in which the inside is made lower in pressure than in the unlock state, and therefore, the clamp device can maintain the lock state in the state in which the pressure of the working fluid is reduced during the vibration test. Thus, it is not necessary to keep the pressure of the working fluid high during the vibration test, and the rotation of the vibration generator relative to the support frame can be reliably restricted during the vibration test. In addition, in the clamp device, since the second member is disposed in the circular hole of the first member, the thickness of the clamp device can be reduced, and the vibration testing device can be made compact.

In the first or second configuration, the support frame may have a bottom frame, and a pair of shaft support frames provided on one end side and the other end side of the bottom frame, the vibration generator may be disposed between the pair of shaft support frames, and the rotary shaft may be supported by the pair of shaft support frames, and the clamp device may be disposed on the surface of each of the pair of shaft support frames opposite to the surface on which the vibration generator is disposed (third configuration).

According to the above configuration, the clamp device is disposed on the surface of each shaft support frame opposite to the surface on which the vibration generator is disposed. Thus, the clamp device can be disposed without influencing the support structure of the vibration generator on the support frame and without expanding an interval between the pair of shaft support frames. Accordingly, the clamp device can be disposed while reducing the influence on the characteristics of the vibration testing device.

In any one of the first to third configurations, the vibration testing device may further include a safety mechanism that prevents the rotation of the vibration generator relative to the support frame, the safety mechanism may have a shaft support member disposed on the support frame to support the rotary shaft and provided with a guide hole, the rotary shaft having a fitting portion provided so as to face the guide hole, a safety pin slidably fitted in the guide hole, and a sliding actuator that slides and moves the safety pin, and operation of the sliding actuator may switch the safety mechanism between an activated state in which the safety pin is fitted in the fitting portion and a deactivated state in which the safety pin is separated from the fitting portion (fourth configuration).

According to the above configuration, the vibration testing device further includes the safety mechanism that prevents the rotation of the vibration generator relative to the support frame. Thus, if the clamp force of the clamp device is reduced or a rotational force exceeding the clamp force of the clamp device is generated, the rotation of the vibration generator can be prevented. Further, since the rotation of the vibration generator relative to the support frame is prevented by fitting the safety pin in the fitting portion provided in the rotary shaft, the rotation of the vibration generator relative to the support frame can be prevented with a simple configuration.

In the fourth configuration, the vibration testing device may have a control unit that controls drive of the clamp device and the safety mechanism, and a clamp operation switch that transmits an operation signal for switching the clamp device between the lock state and the unlock state to the control unit, and the control unit may drive the clamp device based on the operation signal from the clamp operation switch, and may drive the safety mechanism in conjunction with the drive of the clamp device (fifth configuration).

According to the above configuration, the safety mechanism is driven in conjunction with the drive of the clamp device by the operation of the clamp operation switch. Thus, it is possible to save the labor as compared with a case where the drive of the clamp device and the drive of the safety mechanism are performed by different operation switches. Further, since the safety mechanism is driven in conjunction with the drive of the clamp device, it is possible to prevent an operation error of the safety mechanism or forgetting to operate the safety mechanism. Thus, the rotation of the vibration generator relative to the support frame can be safely and reliably restricted during the vibration test.

In the fifth configuration, the vibration testing device may further have a clamp drive detection unit that detects the drive of the clamp device, and the control unit may drive the clamp device based on the operation signal from the clamp operation switch, and may drive the safety mechanism based on a detection signal from the clamp drive detection unit having detected the drive of the clamp device (sixth configuration).

According to the above configuration, when the clamp device is driven by the operation of the clamp operation switch, the drive of the clamp device is detected, and the safety mechanism is driven. Thus, it is possible to save the labor as compared with the case where the drive of the clamp device and the drive of the safety mechanism are performed by the different operation switches. Further, since the safety mechanism is driven when the drive of the clamp device is detected, both the clamp device and the safety mechanism can be reliably driven, and the rotation of the vibration generator relative to the support frame can be safely and reliably restricted during the vibration test.

In the fifth or sixth configuration, the vibration testing device may further have a rotation drive unit that rotates the vibration generator relative to the support frame, a rotation operation switch that transmits an operation signal for rotating the vibration generator relative to the support frame to the control unit, and a safety mechanism drive detection unit that detects whether the safety mechanism is in the activated state or the deactivated state, and when the safety mechanism drive detection unit detects that the safety mechanism is in the deactivated state, the control unit may drive, based on the operation signal from the rotation operation switch, the rotation drive unit to rotate the vibration generator relative to the support frame, and when the safety mechanism drive detection unit detects that the safety mechanism is in the activated state, the control unit may invalidate the operation signal from the rotation operation switch so as not to drive the rotation drive unit (seventh configuration).

According to the above configuration, the vibration generator can be rotated by the drive force of the rotation drive unit, and therefore, the rotation operation of the vibration generator relative to the support frame can be automated. Further, when the safety mechanism is in the activated state, the operation signal from the rotation operation switch is invalidated so as not to drive the rotation drive unit, and therefore, it is possible to prevent the rotation of the vibration generator by the rotation drive unit while the safety mechanism is in the activated state. Thus, it is possible to prevent application of a great load to the safety pin of the safety mechanism.

### First Embodiment

Hereinafter, a vibration testing device 1 according to an embodiment of the present invention will be described in detail with reference to the drawings.

In the figures, the same or corresponding elements are denoted by the same reference numerals, and the description thereof will not be repeated. In the drawings described as a reference, a configuration is simplified or schematically illustrated or some components are omitted, for the sake of easy understanding of the description. Dimensional ratios between the components illustrated in each figure do not necessarily represent actual dimensional ratios.

In the following description, for the sake of convenience in the description, directions may be described using the top and bottom, the left and right, and the front and rear of the vibration testing device 1. In the present embodiment, a direction in which a virtual rotation axis about which a vibration generator 30 rotates relative to a support frame 20 extends is defined as the left-right direction of the vibration testing device 1, and a direction horizontally orthogonal to the direction in which the rotation axis extends is defined as the front-rear direction. In the figure, an arrow U indicates the upward direction of the vibration testing device 1, and an arrow D indicates the downward direction. An arrow R indicates the rightward direction of the vibration testing device 1, and an arrow L indicates the leftward direction. An arrow F indicates the forward direction of the vibration testing device 1, and an arrow B indicates the rearward direction.

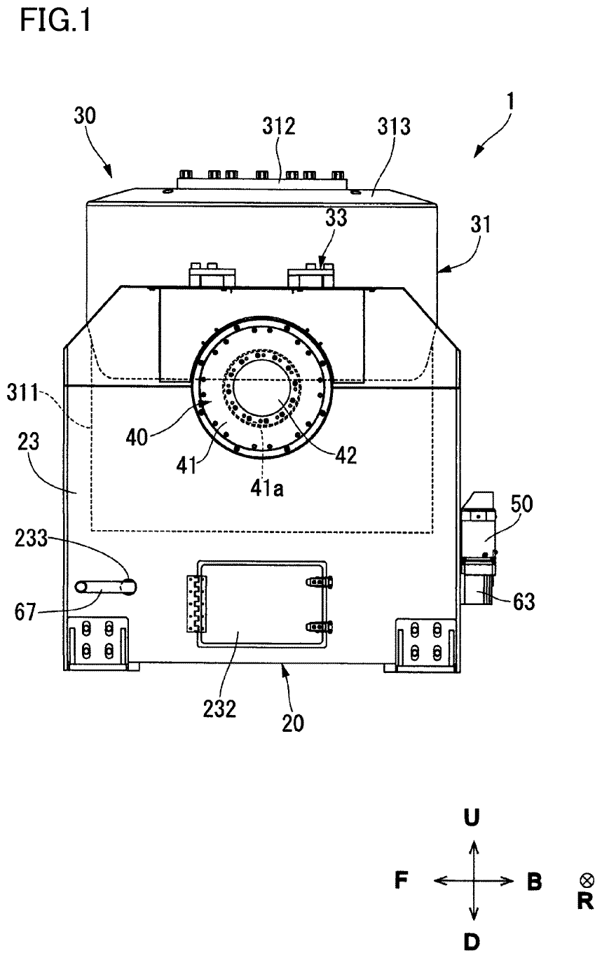

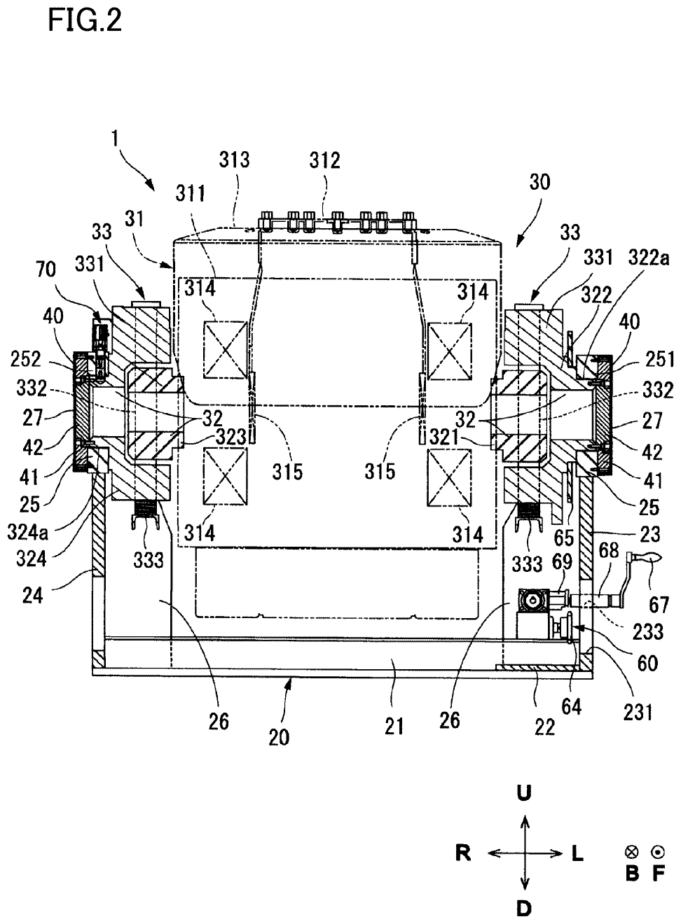

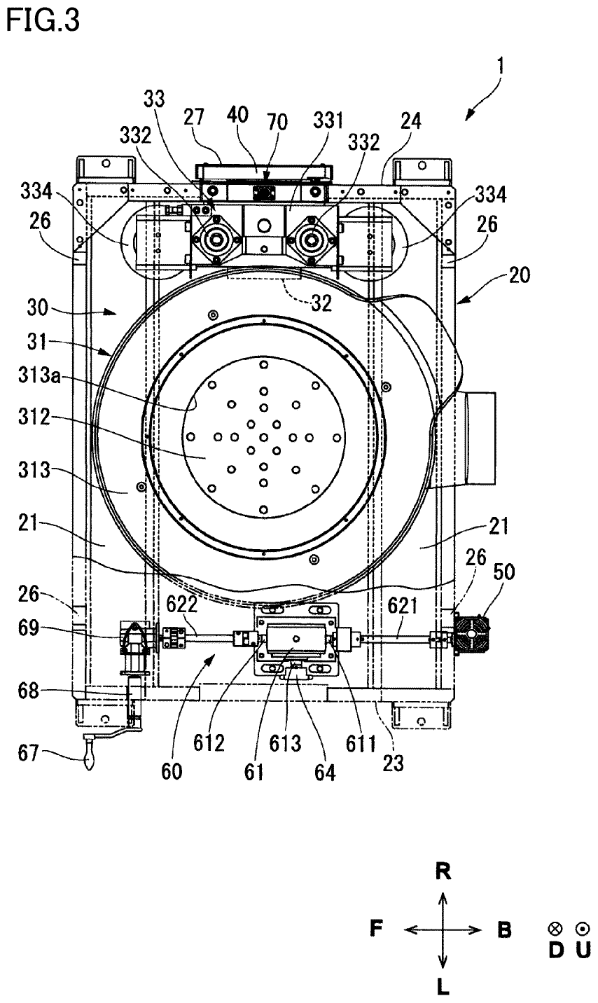

FIG. 1 is a side view of the vibration testing device 1 according to one embodiment of the present invention. FIG. 2 is a front sectional view of the vibration testing device 1. FIG. 3 is a plan view of the vibration testing device 1. As illustrated in FIGS. 1 to 3, the vibration testing device 1 includes a support frame 20, a vibration generator 30, clamp devices 40, 40, a rotation drive unit 60, and a safety mechanism 70.

### [Support Frame]

The support frame 20 rotatably supports the vibration generator 30. The support frame 20 includes a pair of bottom frames 21, 21, a bottom plate 22, a first shaft support frame 23, a second shaft support frame 24, and side plates 26.

The bottom frames 21, 21 are disposed so as to extend in parallel to the left-right direction. The bottom plate 22 is disposed between the front and rear bottom frames 21, 21. The first shaft support frame 23 is disposed so as to extend upward from left end portions of the bottom frames 21, 21. The second shaft support frame 24 is disposed so as to extend upward from right end portions of the bottom frames 21, 21. The side plates 26 are connected to both front and rear end portions of the first shaft support frame 23 and both front and rear end portions of the second shaft support frame 24. The length of each side plate 26 in the left-right direction is short. A space through which a main body 31 of the vibration generator 30 can pass when the vibration direction of the vibration generator 30 is changed is formed between the first shaft support frame 23 and the second shaft support frame 24.

### [Vibration Generator]

The vibration generator 30 includes the main body 31, rotary shafts 32, 32, and vibration absorbers 33, 33.

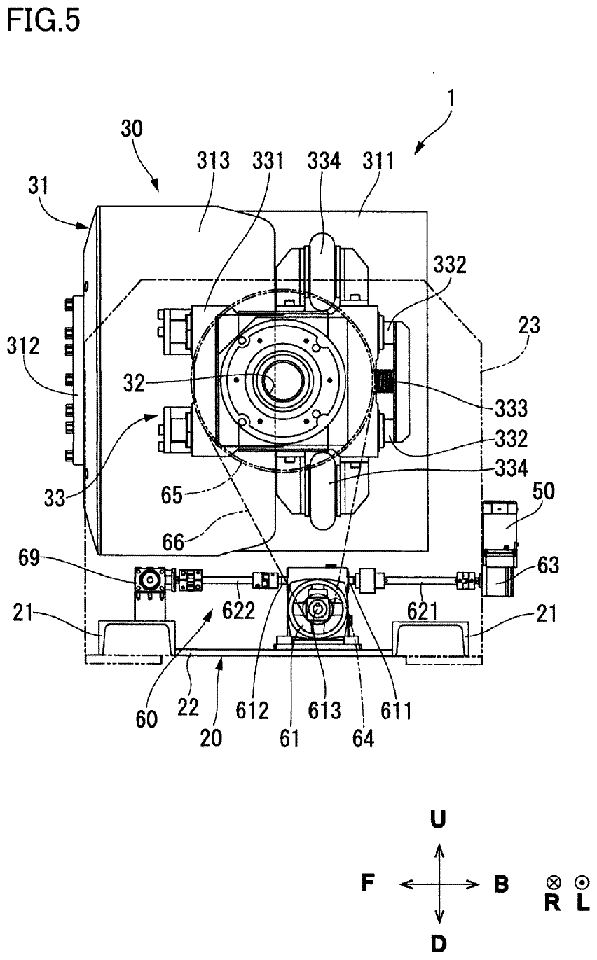

The main body 31 has a substantially circular columnar shape, and has a yoke 311, a vibration table 312, and a cover 313. The yoke 311 is provided with multiple excitation coils 314. In the state of FIGS. 1 to 3, the vibration direction of the vibration generator 30 is the vertical direction, and the vibration generator 30 is disposed so as to vibrate the vibration table 312 in the vertical direction. By rotating the vibration generator 30 relative to the support frame 20, the vibration direction can be changed to the horizontal direction (see FIG. 5).

The vibration table 312 is an element that vibrates a test piece. Specifically, the vibration table 312 vibrates the test piece fixed on the upper surface thereof in the vertical direction in a state in which the vibration direction is the vertical direction. In addition, the vibration table 312 is coupled to a vibration table (not shown) in a state in which the vibration direction is changed to the horizontal direction by rotating the vibration generator 30 by 90 degrees (see FIG. 5), and vibrates the test piece fixed to the vibration table in the horizontal direction. A tubular body is formed in a lower portion of the vibration table 312. A drive coil 315 is attached to a lower portion of the tubular body. The vibration table 312 is supported so as to be movable in an axial direction relative to the yoke 311.

The cover 313 is attached so as to cover an upper portion of the yoke 311. A circular hole 313a (see FIG. 3) is provided in a center portion of the cover 313, and an upper portion of the vibration table 312 is disposed so as to be exposed upward from the circular hole 313a.

When a drive control unit (not shown) that controls the drive of the vibration generator 30 supplies a direct current to the excitation coils 314 via a power amplifier, a magnetic circuit (static magnetic field) is generated in the yoke 311 surrounding the excitation coils 314. When the drive control unit supplies an alternating current with a predetermined frequency to the drive coil 315 disposed in a magnetic gap, the drive coil 315 receives a force whose direction alternately changes in a direction orthogonal to the direction of a magnetic flux due to an interaction (Lorentz force) between the alternating current and the static magnetic field. Accordingly, the drive coil 315 and the vibration table 312 vibrate in the axial direction (vertical direction) according to the frequency of the alternating current.

The rotary shafts 32, 32 are members for rotatably supporting the vibration generator 30 on the support frame 20. The rotary shafts 32, 32 include a pair of rotary shafts 32, 32 provided on the side surfaces of the main body 31 in the left-right direction. As illustrated in FIG. 2, the left rotary shaft 32 has a left first rotary member 321 and a left second rotary member 322. The left first rotary member 321 is attached to the main body 31, and the left second rotary member 322 is rotatably supported on the support frame 20.

The right rotary shaft 32 has a right first rotary member 323 and a right second rotary member 324. The right first rotary member 323 is attached to the main body 31, and the right second rotary member 324 is rotatably supported on the support frame 20.

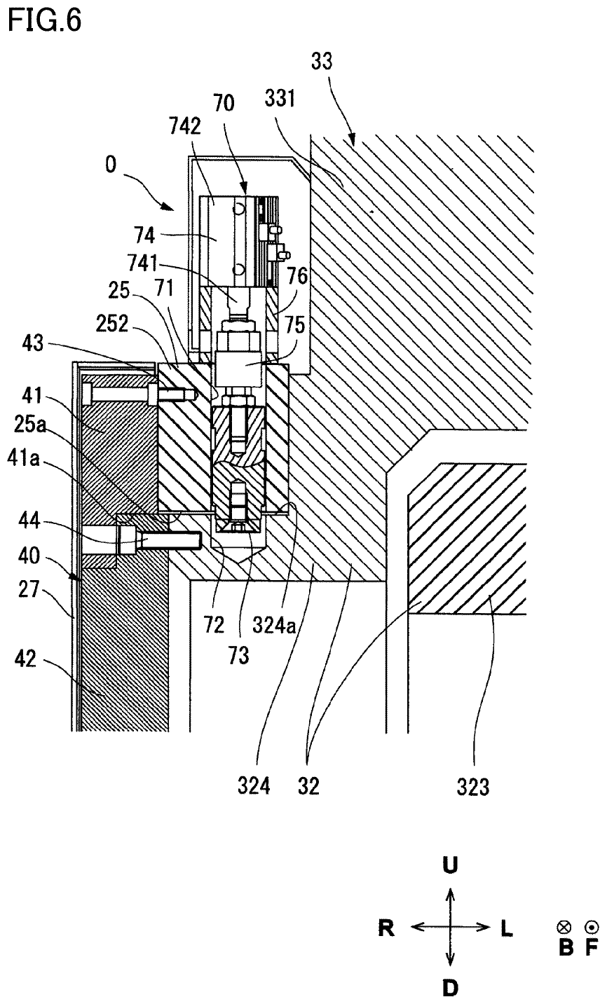

Annular shaft support members 25 (left shaft support member 251 and right shaft support member 252) are attached to the first shaft support frame 23 and second shaft support frame 24 of the support frame 20, respectively. A circular support surface 25a is formed in a center portion of the shaft support member 25 (left shaft support member 251 and right shaft support member 252) (see FIG. 6).

As illustrated in FIG. 2, the left second rotary member 322 has a circular outer peripheral surface 322a around the rotation axis. The left second rotary member 322 has the circular outer peripheral surface 322a rotatably supported by the support surface 25a of the left shaft support member 251. The right second rotary member 324 has a circular outer peripheral surface 324a around the rotation axis. The right second rotary member 324 has the circular outer peripheral surface 324a rotatably supported by the support surface 25a of the right shaft support member 252.

The vibration absorber 33 reduces transmission of the vibration generated by the vibration generator 30 to the support frame 20. As illustrated in FIGS. 2 and 3, the vibration absorbers 33, 33 are provided on the rotary shafts 32, 32.

The vibration absorber 33 has a frame member 331, a guide member 332, a coil spring 333, and an air spring 334.

In the left vibration absorber 33, the frame member 331 is disposed so as to sandwich the rotary shaft 32 in the up-down direction, and extends in the front-rear direction. The frame member 331 is attached and fixed to the left second rotary member 322. The guide member 332 extends in the up-down direction in front and rear of the rotary shaft 32, and is attached and fixed to the frame member 331.

The left first rotary member 321 is attached to the guide member 332 so as to be slidable in the vibration direction. Thus, the left first rotary member 321 is slidable in the vibration direction relative to the left second rotary member 322 supported on the support frame 20.

The air spring 334 is interposed between the frame member 331 and the left first rotary member 321. The air spring 334 absorbs the vibration of the left first rotary member 321 relative to the left second rotary member 322, and supports the weights of the vibration generator 30 and the like so as to keep the height of the vibration generator 30 within a predetermined range with respect to the support frame 20 even when the total weight of the vibration generator 30 and the test piece changes.

Similarly to the left vibration absorber 33, in the right vibration absorber 33, the frame member 331 is disposed above the rotary shaft 32, and extends in the front-rear direction. The frame member 331 is attached and fixed to the right second rotary member 324. The guide member 332 extends in the up-down direction in front and rear of the rotary shaft 32, and is attached and fixed to the frame member 331.

The right first rotary member 323 is attached to the guide member 332 so as to be slidable in the vibration direction. Thus, the right first rotary member 323 is slidable in the vibration direction relative to the right second rotary member 324 supported on the support frame 20.

The air spring 334 is interposed between the frame member 331 and the right first rotary member 323. The air spring 334 absorbs the vibration of the right first rotary member 323 relative to the right second rotary member 324, and supports the weights of the vibration generator 30 and the like so as to keep the height of the vibration generator 30 within a predetermined range with respect to the support frame 20 even when the total weight of the vibration generator 30 and the test piece changes.

The coil spring 333 is disposed below the rotary shaft 32 in each of the left vibration absorber 33 and the right vibration absorber 33. In a state in which the vibration direction of the vibration generator 30 is changed from the vertical direction to the horizontal direction, the weight applied to the air spring 334 supporting the total weight of the vibration generator 30 and the test piece may greatly change, and the spring force of the air spring 334 may become excessive. Even in such a state, the position of the vibration generator 30 needs to be maintained, and for this reason, the coil spring 333 is disposed so as to suppress the excessive spring force of the air spring 334.

### [Clamp Device]

The clamp device 40 switches between a state in which the rotation of the vibration generator 30 relative to the support frame 20 is allowed and a state in which the rotation is restricted. The clamp device 40 of the present embodiment is a gas-pressure-operated clamp device using gas as working fluid. The gas-pressure-operated type is a type of a device operated by the pressure of compressed gas. The gas used as the working fluid for the clamp device 40 is gas which is chemically stable and does not cause environmental pollution. Examples of the gas include air and nitrogen gas. In the present embodiment, the clamp device 40 is described as using compressed air as the working fluid, but the type of gas as the working fluid is not limited thereto. In the following description, the compressed air may be simply referred to as air.

The clamp device 40 has a first member 41 and a second member 42, and is formed in a substantially disc shape. The first member 41 has a circular outer shape, and has a circular hole 41a at the center (see FIG. 6). The second member 42 is disposed and fitted in the circular hole 41a so as to be rotatable relative to the first member 41. The clamp device 40 is configured to be switchable by the air between an unlock state in which relative rotation of the first member 41 and the second member 42 is allowed and a lock state in which the relative rotation of the first member 41 and the second member 42 is restricted.

An elastic member (spring) (not shown) is incorporated into the clamp device 40, and the elastic force of the elastic member acts to bring the clamp device 40 into the lock state in which the relative rotation of the first member 41 and the second member 42 is restricted. By pressurizing the inside with the air from this state, the elastic member is deactivated, and the state is switched to the unlock state in which the relative rotation of the first member 41 and the second member 42 is allowed. Then, by bringing the inside into a state with a lower pressure than that in the unlock state, the elastic force of the elastic member acts, and the state is switched to the lock state in which the relative rotation of the first member 41 and the second member 42 is restricted. An example of the gas-pressure-operated clamp device 40 is “Linear Clamper Zee (registered trade mark) TPS-200 (manufactured by Nabeya Bi-tec Kaisha)”, but the gas-operated clamp device 40 is not limited thereto. Moreover, the configuration of the clamp device is not limited to the configuration of the present embodiment.

The first members 41 are fixed to the shaft support members 25 (left shaft support member 251 and right shaft support member 252) attached to the first shaft support frame 23 and second shaft support frame 24 of the support frame 20 by using multiple first fastening members 43 (see FIG. 6). More specifically, the first member 41 is disposed on the surface of each of the shaft support members 25 (left shaft support member 251 and right shaft support member 252) opposite to the surface on which the vibration generator 30 is disposed. That is, in the first shaft support frame 23, the first member 41 is disposed on the left surface of the left shaft support member 251, and in the second shaft support frame 24, the first member 41 is disposed on the right surface of the right shaft support member 252.

The second member 42 is fixed to the rotary shaft 32 with multiple second fastening members 44 (see FIG. 6). Specifically, the second member 42 of the left clamp device 40 is fixed to the left second rotary member 322 forming the rotary shaft 32, and the second member 42 of the right clamp device 40 is fixed to the right second rotary member 324 forming the rotary shaft 32. With this configuration, the clamp device 40 can switch between the unlock state and the lock state to switch between allowing and restricting the rotation of the vibration generator 30 relative to the support frame 20. In FIGS. 2 and 3, the clamp device 40 is covered with a clamp cover 27 so as to be directly visible from the outside.

### [Rotation Drive Unit]

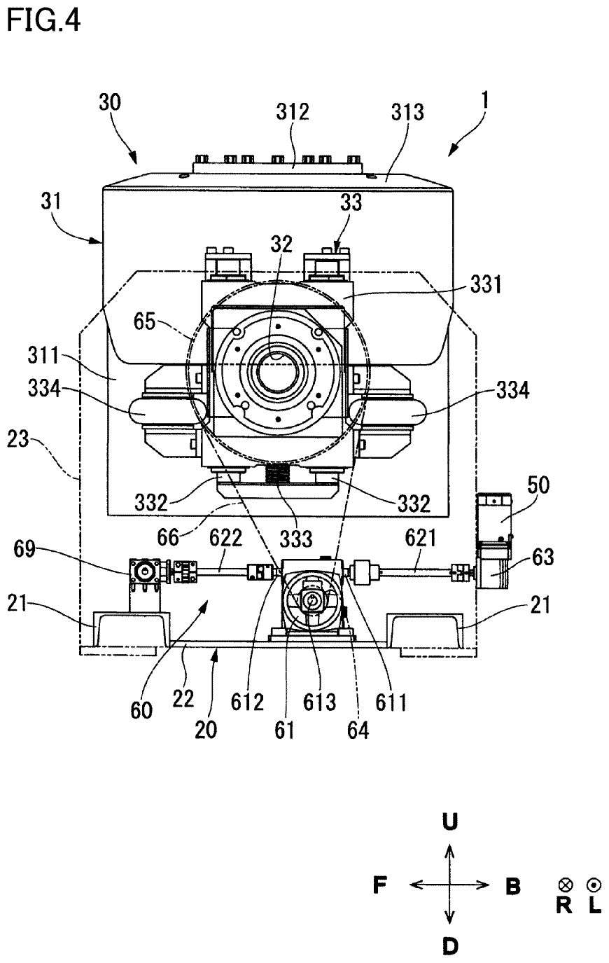

FIG. 4 is a side view of the structures of the vibration generator 30 and the rotation drive unit 60 in the vibration testing device 1. FIG. 5 is a side view of a state in which the vibration generator 30 is rotated by 90 degrees from the state illustrated in FIG. 4. As illustrated in FIGS. 4 and 5, the vibration testing device 1 includes the rotation drive unit 60 that changes the vibration direction between the vertical direction and the horizontal direction by rotating the vibration generator 30 relative to the support frame 20 by the drive force of an electric motor 50. The rotation drive unit 60 includes the electric motor 50, a worm reducer 61, and the like.

The electric motor 50 generates the drive force for rotating the vibration generator 30 relative to the support frame 20. The electric motor 50 is disposed on the side surface of the vibration testing device 1 such that an output shaft thereof is directed downward.

As illustrated in FIGS. 2 to 5, as a mechanism for transmitting the rotational drive force of the electric motor 50 to the rotary shaft 32 of the vibration generator 30, the rotation drive unit 60 includes, in addition to the worm reducer 61, a first power transmission shaft 621, a first direction conversion gear box 63, a first sprocket 64, a second sprocket 65, and a chain 66.

The worm reducer 61 has a first input shaft 611, a second input shaft 612, and an output shaft 613. The first direction conversion gear box 63 is connected to the output shaft of the electric motor 50. An output shaft of the first direction conversion gear box 63 is connected to the first input shaft 611 of the worm reducer 61 via the first power transmission shaft 621.

The output shaft 613 of the worm reducer 61 extends in the left-right direction. The first sprocket 64 is attached to the output shaft 613. As illustrated in FIG. 2, the second sprocket 65 is attached to the left second rotary member 322. As illustrated in FIG. 4, the chain 66 is wound around the first sprocket 64 and the second sprocket 65.

The rotation drive unit 60 transmits the rotational drive force of the electric motor 50 to the left second rotary member 322 via the first direction conversion gear box 63, the first power transmission shaft 621, the worm reducer 61, the first sprocket 64, the chain 66, and the second sprocket 65. Accordingly, the vibration generator 30 can be rotated relative to the support frame 20 by the drive force of the electric motor 50.

In FIG. 4, the orientation of the vibration generator 30 is set such that the vibration direction is the vertical direction. In a case where the vibration direction is changed from the vertical direction to the horizontal direction, the electric motor 50 is driven to rotate the vibration generator 30 by 90 degrees as illustrated in FIG. 5. Although FIG. 5 illustrates the case where the vibration generator 30 is rotated forward by 90 degrees from the state of FIG. 4, the vibration generator 30 may be rotated rearward by 90 degrees from the state of FIG. 4.

The rotation drive unit 60 of the present embodiment is configured to not only change the vibration direction of the vibration generator 30 by the drive force of the electric motor 50, but also manually change the vibration direction of the vibration generator 30. Specifically, as illustrated in FIGS. 2 to 4, the rotation drive unit 60 includes a second power transmission shaft 622, a rotation operation handle 67, a coupling member 68, and a second direction conversion gear box 69.

The rotation operation handle 67 is disposed in a lower portion of the first shaft support frame 23. A rotary shaft of the rotation operation handle 67 is connected to an input shaft of the second direction conversion gear box 69 via the coupling member 68. An output shaft of the second direction conversion gear box 69 is connected to the second input shaft 612 of the worm reducer 61 via the second power transmission shaft 622. The first shaft support frame 23 of the support frame 20 is provided with a handle hole 233 through which the coupling member 68 penetrates.

The rotation drive unit 60 transmits a rotational drive force generated by manually turning the rotation operation handle 67 to the left second rotary member 322 via the coupling member 68, the second direction conversion gear box 69, the second power transmission shaft 622, the worm reducer 61, the first sprocket 64, the chain 66, and the second sprocket 65. Accordingly, the vibration generator 30 can be rotated relative to the support frame 20 by manually turning the rotation operation handle 67.

As illustrated in FIGS. 1 and 2, a maintenance opening 231 and a maintenance door 232 for opening and closing the maintenance opening 231 are provided in a lower central portion of the first shaft support frame 23 of the support frame 20. The maintenance opening 231 is used when maintenance is performed for each component of the rotation drive unit 60 disposed on the back side of the first shaft support frame 23.

### [Safety Mechanism]

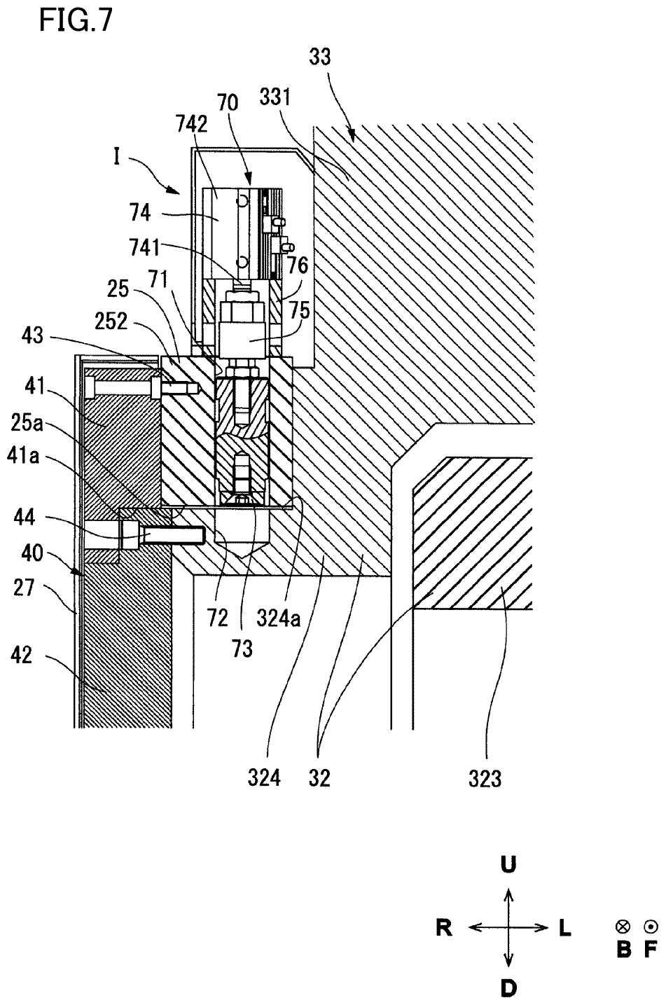

FIG. 6 is a sectional view of a main portion, which illustrates the safety mechanism 70 in an activated state and a peripheral portion thereof. FIG. 7 is a sectional view of the main portion, which illustrates the safety mechanism 70 in a deactivated state and the peripheral portion thereof. As illustrated in FIGS. 2, 3, 6, and 7, the vibration testing device 1 of the present embodiment further includes the safety mechanism 70 that prevents the rotation of the vibration generator 30 relative to the support frame 20, in addition to the clamp device 40.

The safety mechanism 70 includes a guide hole 71, a fitting portion 72, a safety pin 73, and a sliding actuator 74. The guide hole 71 is a through-hole provided in the right shaft support member 252, and an opening is formed in the support surface 25a. The fitting portion 72 is a recess formed in the circular outer peripheral surface 324a of the right second rotary member 324 such that a tip end portion of the safety pin 73 protruding from the guide hole 71 is fitted therein. The position of the fitting portion 72 is set so as to face the guide hole 71 both in a state in which the vibration direction of the vibration generator 30 is the vertical direction and in a state in which the vibration direction is the horizontal direction.

The safety pin 73 is formed in a substantially circular columnar shape. The safety pin 73 is slidably fitted in the guide hole 71 having a circular sectional shape. The sliding actuator 74 includes an air cylinder. The sliding actuator 74 has a cylinder tube 742 and a rod 741 movable linearly relative to the cylinder tube 742. The sliding actuator 74 is attached to an upper portion of the right shaft support member 252 via a tubular member 76. The rod 741 is disposed inside the tubular member 76, and is configured to move in the up-down direction. The tip end of the rod 741 is coupled to the upper end of the safety pin 73 by a coupling member 75.

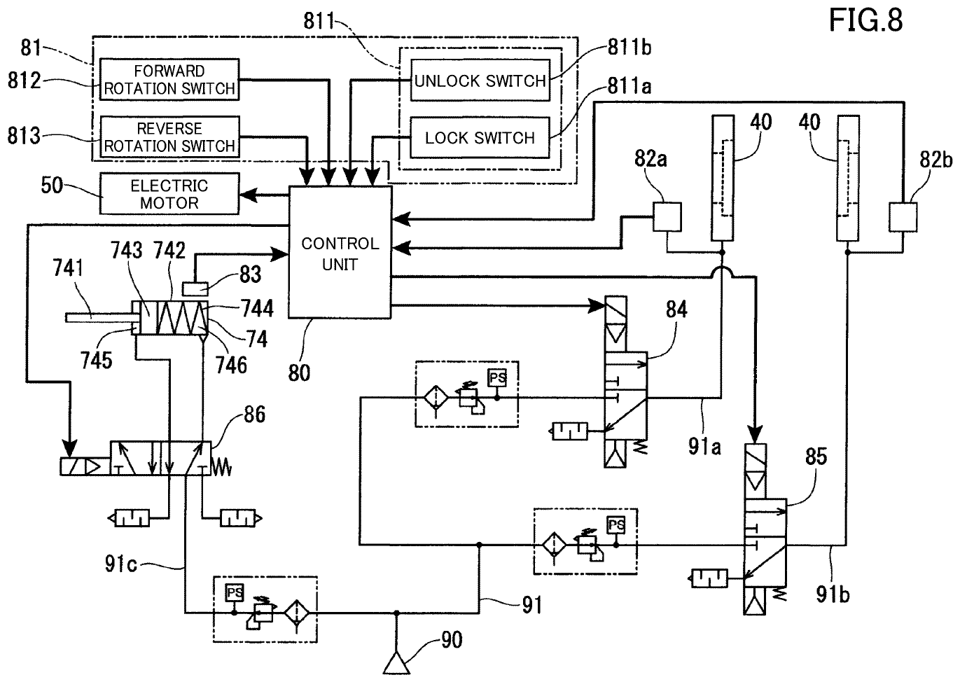

In the sliding actuator 74, the inside of the cylinder tube 742 is partitioned into a head-side chamber 746 and a rod-side chamber 745 by a piston 743 (see FIG. 8). A spring 744 is provided in the head-side chamber 746. The sliding actuator 74 is driven by switching an air supply position at which the air is supplied to the sliding actuator 74 between the head-side chamber 746 and the rod-side chamber 745, thereby switching the safety pin 73 between a protruding state O and a retracted state I. Specifically, when the air is supplied to the head-side chamber 746, the safety pin 73 is brought into the protruding state O by the force of the air and the force of the spring 744. When the air is supplied to the rod-side chamber 745, the safety pin 73 is brought into the retracted state I by the force of the air.

In the protruding state O, the safety pin 73 protrudes from the support surface 25a toward the circular outer peripheral surface 324a. In this state, a tip end portion of the safety pin 73 is fitted in the fitting portion 72, and the rotation of the vibration generator 30 relative to the support frame 20 is prevented. In the present embodiment, a state in which the safety pin 73 is in the protruding state O is defined as the activated state of the safety mechanism 70.

On the other hand, in the retracted state I, the tip end portion of the safety pin 73 is separated from the fitting portion 72, and is retracted into the guide hole 71. In this state, the prevention of the rotation of the vibration generator 30 relative to the support frame 20 is cancelled. In the present embodiment, a state in which the safety pin 73 is in the retracted state I is defined as the deactivated state of the safety mechanism 70.

The safety pin 73 of the sliding actuator 74 is biased by a spring 744 such that the safety pin 73 is in the protruding state O when no air is supplied. Thus, once the safety pin 73 is brought into the protruding state O, the protruding state O is maintained by the biasing force of the spring 744 even when the supply of the air to the sliding actuator 74 is stopped, and the safety mechanism 70 is in the activated state.

### [Pneumatic Circuit and Control]

FIG. 8 is a schematic diagram illustrating a pneumatic circuit and a control system for operating the clamp device 40 and the safety mechanism 70. The clamp device 40 and the sliding actuator 74 of the safety mechanism 70 in the present embodiment are driven by the air. As illustrated in FIG. 8, the pneumatic circuit for such driving is provided with a first solenoid valve 84, a second solenoid valve 85, and a third solenoid valve 86. The first solenoid valve 84, the second solenoid valve 85, the third solenoid valve 86, the pair of clamp devices 40, 40, the sliding actuator 74, and an air source 90 are connected to an air supply path 91.

The first solenoid valve 84 is configured as a four-port two-position directional control valve. The first solenoid valve 84 is provided in an intermediate portion of a first air supply path 91a connecting the air source 90 and the left clamp device 40.

The second solenoid valve 85 is configured as a four-port two-position directional control valve. The second solenoid valve 85 is provided in an intermediate portion of a second air supply path 91b connecting the air source 90 and the right clamp device 40.

The third solenoid valve 86 is configured as a six-port two-position directional control valve. The third solenoid valve 86 is provided in an intermediate portion of a third air supply path 91c connecting the air source 90 and the sliding actuator 74.

A pressure switch 82a is provided in the vicinity of the left clamp device 40 in the first air supply path 91a. The pressure switch 82a is provided between the first solenoid valve 84 and the left clamp device 40 in the first air supply path 91a. The pressure switch 82a detects the drive of the left clamp device 40, and corresponds to a clamp drive detection unit of the present invention.

A pressure switch 82b is provided in the vicinity of the right clamp device 40 in the second air supply path 91b. The pressure switch 82b is provided between the second solenoid valve 85 and the right clamp device 40 in the second air supply path 91b. The pressure switch 82b detects the drive of the right clamp device 40, and corresponds to the clamp drive detection unit of the present invention.

The sliding actuator 74 of the safety mechanism 70 is provided with a position sensor 83 that detects the position of the rod 741. The position sensor 83 detects whether the sliding actuator 74 is in the protruding state O or the retracted state I, and detects whether the safety mechanism 70 is in the activated state or the deactivated state, and corresponds to a safety mechanism drive detection unit of the present invention.

The vibration testing device 1 of the present embodiment includes a control unit 80 and an operation unit 81. The control unit 80 controls the drive of the pair of clamp devices 40, 40, the drive of the sliding actuator 74 of the safety mechanism 70, and the drive of the electric motor 50 of the rotation drive unit 60.

The control unit 80 is electrically connected to the first solenoid valve 84, the second solenoid valve 85, the third solenoid valve 86, the pressure switch 82a, the pressure switch 82b, the position sensor 83, the electric motor 50, and the operation unit 81. The operation unit 81 is operated by an operator, and transmits an operation signal to the control unit 80.

The operation unit 81 has a clamp operation switch 811, a forward rotation switch 812 that causes the electric motor 50 to rotate forward, and a reverse rotation switch 813 that causes the electric motor 50 to rotate in reverse.

The clamp operation switch 811 is provided to switch the clamp device 40 between the lock state and the unlock state. In the present embodiment, the clamp operation switch 811 has a lock switch 811a for bringing the clamp device 40 into the lock state and an unlock switch 811b for bringing the clamp device 40 into the unlock state.

In the present embodiment, the clamp operation switches 811 (lock switch 811a and unlock switch 811b) also each serve as an operation switch of the safety mechanism 70. When the clamp operation switch 811 is operated, the control unit 80 drives the clamp device 40 and the safety mechanism 70 (sliding actuator 74) in conjunction with each other. Specifically, when the lock switch 811a is operated, the clamp device 40 is brought into the lock state, and the safety mechanism 70 is brought into the activated state. When the unlock switch 811b is operated, the clamp device 40 is brought into the unlock state, and the safety mechanism 70 is brought into the deactivated state. The clamp device 40 and the safety mechanism 70 (sliding actuator 74) are operated in conjunction with each other based on detection of the pressure switch 82a and the pressure switch 82b.

The forward rotation switch 812 and the reverse rotation switch 813 are provided to rotate the vibration generator 30 forward or in reverse relative to the support frame 20. When the forward rotation switch 812 is operated, the operation signal for rotating the vibration generator 30 forward is transmitted to the control unit 80. The control unit 80 drives the electric motor 50 of the rotation drive unit 60 in a forward rotation direction, and the vibration generator 30 is rotated forward in either one of the forward or rearward direction relative to the support frame 20. When the reverse rotation switch 813 is operated, the operation signal for rotating the vibration generator 30 in reverse is transmitted to the control unit 80. The control unit 80 drives the electric motor 50 of the rotation drive unit 60 in a reverse rotation direction, and the vibration generator 30 is rotated in reverse in the other one of the forward or rearward direction relative to the support frame 20. The forward rotation switch 812 and the reverse rotation switch 813 correspond to a rotation operation switch of the present invention.

In the present embodiment, when the safety mechanism 70 is in the activated state, the operation signal is invalidated even if either the forward rotation switch 812 or the reverse rotation switch 813 is operated, and the drive of the electric motor 50 of the rotation drive unit 60 is restricted, and therefore, the vibration generator 30 is not rotated. On the other hand, when the safety mechanism 70 is in the deactivated state, the operation signal is validated even if either the forward rotation switch 812 or the reverse rotation switch 813 is operated, and the electric motor 50 of the rotation drive unit 60 is driven to rotate the vibration generator 30 forward or in reverse relative to the support frame 20.

### [Operation of Clamp Device and Safety Mechanism]

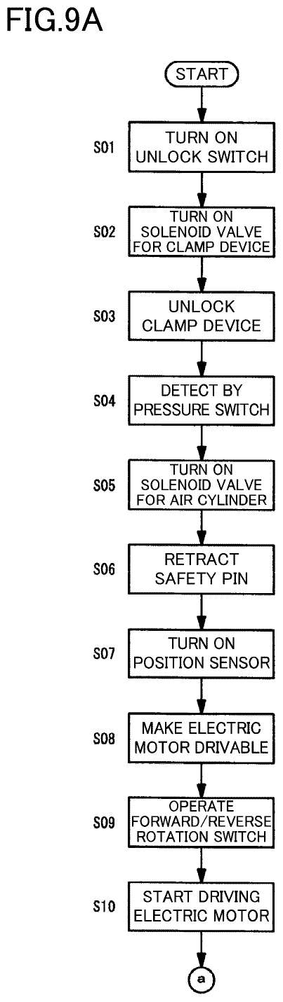

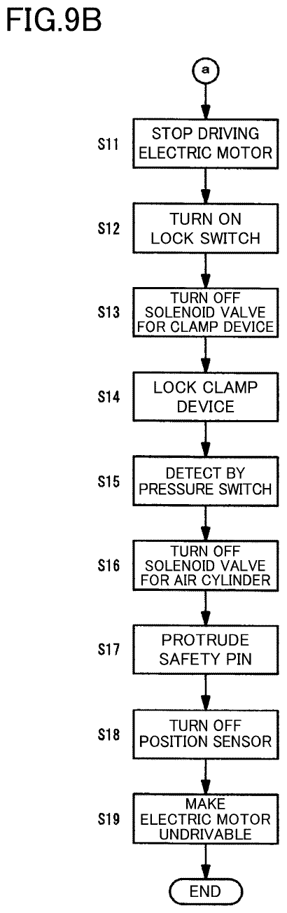

FIGS. 9A and 9B are flowcharts for describing the operations of the clamp device 40 and the safety mechanism 70. Hereinafter, specific control operations by the control unit 80 will be described with reference to FIGS. 9A and 9B.

First, when the unlock switch 811b is turned on in Step S01 of FIG. 9A, the operation signal from the unlock switch 811b is input to the control unit 80.

In Step S02, when the operation signal from the unlock switch 811b is input to the control unit 80, the control unit 80 turns on the first solenoid valve 84 and the second solenoid valve 85 based on the operation signal from the unlock switch 811b.

When the first solenoid valve 84 and the second solenoid valve 85 are turned on, in Step S03, the air from the air source 90 is supplied to the left clamp device 40 through the first air supply path 91a, and the left clamp device 40 is brought into the unlock state. At the same time, the air from the air source 90 is supplied to the right clamp device 40 through the second air supply path 91b, and the right clamp device 40 is brought into the unlock state.

When the air from the air source 90 is supplied to the left clamp device 40 and the right clamp device 40 in Step S03, the air is also supplied to the pressure switch 82a and the pressure switch 82b. In Step S04, the air is supplied to the pressure switch 82a and the pressure switch 82b, whereby the pressure switch 82a and the pressure switch 82b transmit detection signals to the control unit 80.

In Step S05, when the detection signals from the pressure switch 82a and the pressure switch 82b are input to the control unit 80, the control unit 80 turns on the third solenoid valve 86 based on the detection signals from the pressure switch 82a and the pressure switch 82b.

When the third solenoid valve 86 is turned on, in Step S06, the air from the air source 90 is supplied to the head-side chamber 746 of the sliding actuator 74 (air cylinder) of the safety mechanism 70 through the third air supply path 91c, and the safety pin 73 is switched from the protruding state O to the retracted state I.

When the safety pin 73 is switched to the retracted state I, in Step S07, the position sensor 83 having detected the upward movement of the rod 741 of the sliding actuator 74 is turned on, and transmits a detection signal to the control unit 80.

In Step S08, the control unit 80 detects that the safety mechanism 70 is in the deactivated state based on the detection signal from the position sensor 83, and therefore, the electric motor 50 of the rotation drive unit 60 can be driven.

When the forward rotation switch 812 or the reverse rotation switch 813 is operated in

Step S09, the operation signal from the forward rotation switch 812 or the reverse rotation switch 813 is input to the control unit 80, and the operation signal is validated because the safety mechanism 70 is in the deactivated state.

In Step S10, the control unit 80 drives the electric motor 50 of the rotation drive unit 60 based on the operation signal from the forward rotation switch 812 or the reverse rotation switch 813, and rotates the vibration generator 30 forward or in reverse relative to the support frame 20. In this manner, in a state in which it is certain that the clamp device 40 is in the unlock state and the safety mechanism 70 is in the deactivated state, the vibration generator 30 is rotated so that a process of changing the vibration direction of the vibration generator 30 can be performed.

Subsequently, in Step S11 of FIG. 9B, the vibration generator 30 is rotated forward or in reverse relative to the support frame 20, and the drive of the electric motor 50 of the rotation drive unit 60 is stopped in a state in which the vibration direction of the vibration generator 130 is changed to the vertical direction or the horizontal direction.

When the drive of the electric motor 50 of the rotation drive unit 60 is stopped, the operator turns on the lock switch 811a. When the lock switch 811a is turned on in Step S12, the operation signal from the lock switch 811a is input to the control unit 80.

In Step S13, when the operation signal from the lock switch 811a is input to the control unit 80, the control unit 80 turns off the first solenoid valve 84 and the second solenoid valve 85 based on the operation signal from the lock switch 811a.

When the first solenoid valve 84 and the second solenoid valve 85 are turned off, in Step S14, the supply of the air from the air source 90 to the left clamp device 40 and the right clamp device 40 is stopped, and the internal pressure reaches lower than that in the unlock state, whereby the left clamp device 40 and the right clamp device 40 are brought into the lock state.

When the supply of the air from the air source 90 to the left clamp device 40 and the right clamp device 40 is stopped in Step S14, the supply of the air to the pressure switch 82a and the pressure switch 82b is also stopped. In Step S15, the supply of the air to the pressure switch 82a and the pressure switch 82b is stopped, whereby the pressure switch 82a and the pressure switch 82b transmit detection signals to the control unit 80.

In Step S16, when the detection signals from the pressure switch 82a and the pressure switch 82b are input to the control unit 80, the control unit 80 turns off the third solenoid valve 86 based on the detection signals from the pressure switch 82a and the pressure switch 82b.

When the third solenoid valve 86 is turned off, in Step S17, the air from the air source 90 is supplied to the rod-side chamber 745 of the sliding actuator 74 (air cylinder) of the safety mechanism 70 through the third air supply path 91c, and the safety pin 73 is switched from the retracted state I to the protruding state O.

When the safety pin 73 is switched to the protruding state O, in Step S18, the position sensor 83 having detected the downward movement of the rod 741 of the sliding actuator 74 is turned off, and transmits a detection signal to the control unit 80.

In Step S19, the control unit 80 detects that the safety mechanism 70 is in the activated state based on the detection signal from the position sensor 83, and therefore, the electric motor 50 of the rotation drive unit 60 is not driven. That is, when the safety mechanism 70 is in the activated state, if the forward rotation switch 812 or the reverse rotation switch 813 is operated, the operation signal is invalidated, and the electric motor 50 of the rotation drive unit 60 is not driven (end).

As described above, the vibration testing device 1 according to the present embodiment includes the support frame 20, the vibration generator 30 having the rotary shaft 32 rotatably supported on the support frame 20, and the clamp device 40 using the compressed air as the working fluid, the clamp device 40 has the first member 41 and the second member 42, and is configured to be switchable by the compressed air between the unlock state in which the relative rotation of the first member 41 and the second member 42 is allowed and the lock state in which the relative rotation of the first member 41 and the second member 42 is restricted, either one of the first member 41 or the second member 42 is fixed to the support frame 20, the other one of the first member 41 or the second member 42 is fixed to the rotary shaft 32, and the clamp device 40 switches between the unlock state and the lock state to switch between allowing and restricting the rotation of the vibration generator 30 relative to the support frame 20.

With the above configuration, by controlling the compressed air as the working fluid, it is possible to automate the allowing and restricting the rotation of the vibration generator 30. Thus, a process of attaching and detaching a fastening member for fastening the support frame and the vibration generator as in the known vibration testing device is not required, and a labor for a process of changing the vibration direction of the vibration generator can be saved. In addition, in the lock state of the clamp device 40, the relative rotation of the rotary shaft 32 of the vibration generator 30 and the support frame 20 is restricted, and therefore the rotation of the vibration generator 30 relative to the support frame 20 can be reliably restricted during a vibration test. Further, since the clamp device 40 uses the compressed air as the working fluid, there is no leakage of hydraulic oil as in a case of using a hydraulic mechanism, and contamination of test environment can be reduced.

The clamp device 40 of the vibration testing device 1 has the first member 41 having the circular hole 41a, and the second member 42 disposed in the circular hole 41a so as to be rotatable relative to the first member 41, and is configured to be switched to the unlock state in the state in which the inside is pressurized by the compressed air and to be switched to the lock state in the state in which the inside is made lower in pressure than in the unlock state, the first member 41 is fixed to the support frame 20, and the second member 42 is fixed to the rotary shaft 32.

With the above configuration, the clamp device 40 is switched to the lock state in the state in which the internal pressure is lower than that in the unlock state, and therefore, the clamp device 40 can maintain the lock state in the state in which the pressure inside the clamp device 40 is reduced during the vibration test. Thus, it is not necessary to keep the pressure of the compressed air high during the vibration test, and the rotation of the vibration generator 30 relative to the support frame 20 can be reliably restricted during the vibration test. In addition, in the clamp device 40, since the second member 42 is disposed in the circular hole 41a of the first member 41, the thickness of the clamp device 40 can be reduced, and the vibration testing device 1 can be made compact.

The support frame 20 has the bottom frame 21, the first shaft support frame 23 provided at the left end portion of the bottom frame 21, and the second shaft support frame 24 provided at the right end portion of the bottom frame 21, the vibration generator 30 is disposed between the first shaft support frame 23 and the second shaft support frame 24, and the rotary shafts 32, 32 are supported by the first shaft support frame 23 and the second shaft support frame 24, and the clamp device 40 is disposed on the surface of each of the first shaft support frame 23 and the second shaft support frame 24 opposite to the surface on which the vibration generator 30 is disposed.

With the above configuration, the clamp device 40 is disposed on the surface of each of the first shaft support frame 23 and the second shaft support frame 24 opposite to the surface on which the vibration generator 30 is disposed. Thus, the clamp device 40 can be disposed without influencing the support structure of the vibration generator 30 on the support frame 20 and without expanding an interval between the first shaft support frame 23 and the second shaft support frame 24. Accordingly, the clamp device 40 can be disposed while reducing the influence on the characteristics of the vibration testing device 1.

The vibration testing device 1 further includes the safety mechanism 70 that prevents the rotation of the vibration generator 30 relative to the support frame 20, the safety mechanism 70 has the shaft support member 25 disposed on the support frame 20 to support the rotary shaft 32 and provided with the guide hole 71, the rotary shaft 32 having the fitting portion 72 provided so as to face the guide hole 71, the safety pin 73 slidably fitted in the guide hole 71, and the sliding actuator 74 that slides and moves the safety pin 73, and the operation of the sliding actuator 74 switches the safety mechanism 70 between the activated state in which the safety pin 73 is fitted in the fitting portion 72 and the deactivated state in which the safety pin 73 is separated from the fitting portion 72.

With the above configuration, the vibration testing device 1 further includes the safety mechanism 70 that prevents the rotation of the vibration generator 30 relative to the support frame 20. Thus, if the clamp force of the clamp device 40 is reduced or a rotational force exceeding the clamp force of the clamp device 40 is generated, the rotation of the vibration generator 30 can be prevented. Further, since the rotation of the vibration generator 30 relative to the support frame 20 is prevented by fitting the safety pin 73 in the fitting portion 72 provided in the rotary shaft 32, the rotation of the vibration generator 30 relative to the support frame 20 can be prevented with a simple configuration.

The vibration testing device 1 has the control unit 80 that controls the drive of the clamp device 40 and the safety mechanism 70, and the clamp operation switch 811 that transmits the operation signal for switching the clamp device 40 between the lock state and the unlock state to the control unit 80, and the control unit 80 drives the clamp device 40 based on the operation signal from the clamp operation switch 811, and drives the safety mechanism 70 in conjunction with the drive of the clamp device 40.

With the above configuration, the safety mechanism 70 is driven in conjunction with the drive of the clamp device 40 by the operation of the clamp operation switch 811. Thus, it is possible to save the labor as compared with a case where the drive of the clamp device 40 and the drive of the safety mechanism 70 are performed by different operation switches. Further, since the safety mechanism 70 is driven in conjunction with the drive of the clamp device 40, it is possible to prevent an operation error of the safety mechanism 70 or forgetting to operate the safety mechanism 70. Thus, the rotation of the vibration generator 30 relative to the support frame 20 can be safely and reliably restricted during the vibration test.

The vibration testing device 1 further has the pressure switch 82a and the pressure switch 82b (clamp drive detection unit) that detect the drive of the clamp device 40, and the control unit 80 drives the clamp device 40 based on the operation signal from the clamp operation switch 811, and drives the safety mechanism 70 based on the detection signals from the pressure switch 82a and the pressure switch 82b (clamp drive detection unit) having detected the drive of the clamp device 40.

With the above configuration, when the clamp device 40 is driven by the operation of the clamp operation switch 811, the drive of the clamp device 40 is detected, and the safety mechanism 70 is driven. Thus, it is possible to save the labor as compared with the case where the drive of the clamp device 40 and the drive of the safety mechanism 70 are performed by the different operation switches. Further, since the safety mechanism 70 is driven when the drive of the clamp device 40 is detected, both the clamp device 40 and the safety mechanism 70 can be reliably driven, and the rotation of the vibration generator 30 relative to the support frame 20 can be safely and reliably restricted during the vibration test. In addition, in the present embodiment, since both the clamp device 40 and the safety mechanism 70 have the mechanisms operated with gas, these components can be operated by the common pneumatic circuit, and the mechanism for automatically restricting the rotation of the vibration generator can be simplified.

The vibration testing device 1 further has the rotation drive unit 60 that rotates the vibration generator 30 relative to the support frame 20, the forward rotation switch 812 and the reverse rotation switch 813 (rotation operation switches) that transmit the operation signal for rotating the vibration generator 30 relative to the support frame 20 to the control unit 80, and the position sensor 83 (safety mechanism drive detection unit) that detects whether the safety mechanism 70 is in the activated state or the deactivated state, when the position sensor 83 (safety mechanism drive detection unit) detects that the safety mechanism 70 is in the deactivated state, the control unit 80 drives, based on the operation signal from the forward rotation switch 812 or the reverse rotation switch 813 (rotation operation switch), the rotation drive unit 60 to rotate the vibration generator 30 relative to the support frame 20, and when the position sensor 83 (safety mechanism drive detection unit) detects that the safety mechanism 70 is in the activated state, the control unit 80 invalidates the operation signal from the forward rotation switch 812 or the reverse rotation switch 813 (rotation operation switch) so as not to drive the rotation drive unit 60.

With the above configuration, the vibration generator 30 can be rotated by the drive force of the rotation drive unit 60, and therefore, the rotation operation of the vibration generator 30 relative to the support frame 20 can be automated. Further, when the safety mechanism 70 is in the activated state, the operation signal from the forward rotation switch 812 or the reverse rotation switch 813 (rotation operation switch) is invalidated so as not to drive the rotation drive unit 60, and therefore, it is possible to prevent the rotation of the vibration generator 30 by the rotation drive unit 60 while the safety mechanism 70 is in the activated state. Thus, it is possible to prevent application of a great load to the safety pin 73 of the safety mechanism 70.

### <Variations>

The vibration testing device according to the present invention is not limited to that of the present embodiment described above. The embodiments disclosed herein are illustrative in all respects, and are not the basis of limited interpretation. The technical scope of the present invention is not interpreted only by the above embodiments, but is defined based on the description of the claims. The technical scope of the present invention includes all modifications within the meaning and scope equivalent to the scope of the claims.

For example, in the above embodiments, the safety mechanism 70 is provided in addition to the clamp device 40. The present invention is not limited thereto, and may be a vibration testing device including no safety mechanism. In the above embodiments, the sliding actuator 74 of the safety mechanism 70 includes the air cylinder. The present invention is not limited thereto, and an electric cylinder or an electric actuator other than a cylinder may be adopted.

In the above embodiment, when the clamp operation switch 811 is operated, the control unit 80 drives the clamp device 40 and the sliding actuator 74 of the safety mechanism 70 in conjunction with each other. The present invention is not limited thereto, and an operation switch for driving the clamp device and an operation switch for operating the safety mechanism may be provided separately.

In the above embodiments, the rotation drive unit 60 that rotates the vibration generator 30 by the electric motor 50 is provided. The present invention is not limited thereto, and the vibration generator may be rotated only manually.

### INDUSTRIAL APPLICABILITY

The present invention is applicable to a vibration testing device capable of changing the vibration direction of a vibration generator by rotating the vibration generator relative to a support frame.

### DESCRIPTION OF REFERENCE CHARACTERS

1 Vibration Testing Device
20 Support Frame
25 Shaft Support Member
25a Support Surface
30 Vibration Generator
32 Rotary Shaft
40 Clamp Device
41 First Member
41a Circular Hole
42 Second Member
50 Electric Motor
60 Rotation Drive Unit
70 Safety Mechanism
71 Guide Hole
72 Fitting Portion
73 Safety Pin
74 Sliding Actuator
80 Control Unit
81 Operation Unit
324a Circular Outer Peripheral Surface
811 Clamp Operation Switch
0 Protruding State
I Retracted State

1. A vibration testing device capable of changing a vibration direction of a vibration generator, the vibration testing device comprising:
a support frame;
a vibration generator having a rotary shaft rotatably supported on the support frame; and
a clamp device using gas as working fluid, wherein
the clamp device has a first member and a second member, and is configured to be switchable by the working fluid between an unlock state in which relative rotation of the first member and the second member is allowed and a lock state in which the relative rotation of the first member and the second member is restricted,
either one of the first member or the second member is fixed to the support frame,
the other one of the first member or the second member is fixed to the rotary shaft, and
the clamp device switches between the unlock state and the lock state to switch between allowing and restricting rotation of the vibration generator relative to the support frame.

2. The vibration testing device of claim 1, wherein
the clamp device
has the first member having a circular hole, and the second member disposed in the circular hole so as to be rotatable relative to the first member, and
is configured to be switched to the unlock state in a state in which an inside is pressurized by the working fluid and to be switched to the lock state in a state in which the inside is made lower in pressure than in the unlock state,
the first member is fixed to the support frame, and
the second member is fixed to the rotary shaft.

3. The vibration testing device of claim 1, wherein
the support frame has a bottom frame, and a pair of shaft support frames provided on one end side and the other end side of the bottom frame,
the vibration generator is disposed between the pair of shaft support frames, and the rotary shaft is supported by the pair of shaft support frames, and
the clamp device is disposed on a surface of each of the pair of shaft support frames opposite to a surface on which the vibration generator is disposed.

4. The vibration testing device of claim 1, further comprising:
a safety mechanism that prevents the rotation of the vibration generator relative to the support frame, wherein
the safety mechanism has
a shaft support member disposed on the support frame to support the rotary shaft and provided with a guide hole,
the rotary shaft having a fitting portion provided so as to face the guide hole,
a safety pin slidably fitted in the guide hole, and
a sliding actuator that slides and moves the safety pin,
and
operation of the sliding actuator switches the safety mechanism between an activated state in which the safety pin is fitted in the fitting portion and a deactivated state in which the safety pin is separated from the fitting portion.

5. The vibration testing device of claim 4, further comprising:
a control unit that controls drive of the clamp device and the safety mechanism; and
a clamp operation switch that transmits an operation signal for switching the clamp device between the lock state and the unlock state to the control unit, wherein
the control unit drives the clamp device based on the operation signal from the clamp operation switch, and drives the safety mechanism in conjunction with the drive of the clamp device.

6. The vibration testing device of claim 5, further comprising:
a clamp drive detection unit that detects the drive of the clamp device, wherein the control unit
drives the clamp device based on the operation signal from the clamp operation switch, and
drives the safety mechanism based on a detection signal from the clamp drive detection unit having detected the drive of the clamp device.

7. The vibration testing device of claim 5, further comprising:
a rotation drive unit that rotates the vibration generator relative to the support frame;
a rotation operation switch that transmits an operation signal for rotating the vibration generator relative to the support frame to the control unit; and
a safety mechanism drive detection unit that detects whether the safety mechanism is in the activated state or the deactivated state, wherein
when the safety mechanism drive detection unit detects that the safety mechanism is in the deactivated state, the control unit drives, based on the operation signal from the rotation operation switch, the rotation drive unit to rotate the vibration generator relative to the support frame, and
when the safety mechanism drive detection unit detects that the safety mechanism is in the activated state, the control unit invalidates the operation signal from the rotation operation switch so as not to drive the rotation drive unit.
